(19) United States
(12) Patent Application Publication
(10) Pub. No.: US 2026/0228002 A1
(43) Pub. Date: Aug. 6, 2026

(54) SCALE INSTRUCTION FOR DATA NORMALIZATION

(71) Applicant: QUALCOMM Incorporated, San Diego, CA (US)

(72) Inventors: Lingjun Chen, San Diego, CA (US); Sheng Gu, San Diego, CA (US); Tao Wang, Sunnyvale, CA (US); Yun Du, San Diego, CA (US); Gang Zhong, San Diego, CA (US)

(21) Appl. No.: 19/045,162

(22) Filed: Feb. 4, 2025

(51) Int. Cl. G06F 9/30

(52) U.S. Cl. CPC G06F 9/30018

(57) ABSTRACT

This disclosure provides systems, methods, and devices that implement a scale instruction within processing circuitry to efficiently scale multiple input values. The apparatus includes processing circuitry configured to detect a scale instruction among fetched instructions. Upon executing the scale instruction, the processing circuitry determines a scaling factor based on a plurality of input values, such as by selecting the maximum absolute value or the largest power of two less than or equal to it. The processing circuitry then outputs at least one of the scaling factor, one or more scaled output values derived from the input values, or both. Other aspects and features are also claimed and described.

### TECHNICAL FIELD

Aspects of the present disclosure relate generally to integrated circuits, and more particularly, to integrated circuits for improving processing systems such as may be used in system on chips (SoCs). Some features may enable and provide a scale instruction for scaling data inputs.

### INTRODUCTION

Central Processing Units (CPUs) operate based on a set of predefined instructions known as the Instruction Set Architecture (ISA). These instructions define how the processor handles data, performs calculations, and communicates with memory and peripheral devices. CPU instructions encompass various operations, including arithmetic computations, logical operations, data movement, and control flow management. Arithmetic instructions, in particular, may handle both integer and floating-point numbers, enabling the processor to perform a wide range of mathematical calculations required by modern applications. Floating-point arithmetic is used for computations involving real numbers, such as in fields like scientific simulations, graphics rendering, and signal processing. These operations often require high precision and the ability to represent a vast range of values.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some aspects, the present techniques introduce a new hardware CPU instruction, referred to as a scale instruction, designed to efficiently handle the scaling and normalization of multiple data inputs, such as floating-point input values. When executed by processing circuitry within the processor, this scale instruction identifies multiple input values to be scaled and determines a scaling factor based on these values. Specifically, the scale instruction may select the maximum absolute value among the inputs and adjust it to the largest power of two less than or equal to that value by modifying the exponent bits directly.

By adjusting the exponent bits of the floating-point representations using integer logic operations, the scale instruction generates scaled output values without performing traditional floating-point multiplication or division operations. This process occurs within the Arithmetic Logic Unit (ALU) of the processor, enabling efficient hardware execution. The result of executing the scale instruction includes outputting at least one of the scaling factor, the scaled output values, or a combination thereof. These outputs can then be used in subsequent computations to prevent overflow or underflow in floating-point operations. By integrating this scaling operation into hardware, these techniques may enhance computational efficiency, reduce the number of instructions executed, and minimize rounding errors compared to software-based scaling methods.

In one aspect, an apparatus includes processing circuitry configured to perform data processing in response to instructions, where the processing circuitry is further configured to detect, among the instructions, a scale instruction that identifies a plurality of input values to be scaled; execute the scale instruction to determine a scaling factor based on the plurality of input values; and output at least one of the scaling factor, one or more scaled output values determined based on the plurality of input values, or a combination thereof.

In another aspect, a method includes detecting, among instructions fetched from a data store for execution by processing circuitry, a scale instruction that identifies a plurality of input values to be scaled; executing, by the processing circuitry, the scale instruction to determine a scaling factor based on the plurality of input values; and outputting, from executing the scale instruction, at least one of the scaling factor, one or more scaled output values determined based on the plurality of input values, or a combination thereof.

In a further aspect, a non-transitory computer-readable medium stores instructions which, when executed by a processor, cause the processor to perform operations including detecting, among instructions fetched from a data store for execution by processing circuitry, a scale instruction that identifies a plurality of input values to be scaled; executing, by the processing circuitry, the scale instruction to determine a scaling factor based on the plurality of input values; and outputting, from executing the scale instruction, at least one of the scaling factor, one or more scaled output values determined based on the plurality of input values, or a combination thereof.

The integrated circuits and System on Chips (SoCs) described herein may be used for processing of various kinds of data, including audio signal processing, video processing, artificial intelligence (AI) processing, mathematical computations, database processing, image processing, and other kinds of data processing. These integrated circuits and/or SoCs can be incorporated into a wide variety of devices. By way of example, they may be incorporated into stand-alone audio devices, such as entertainment devices and personal media players, wireless communication device handsets such as mobile telephones, cellular or satellite radio telephones, personal digital assistants (PDAs), tablets, gaming devices, computing devices such as webcams, video surveillance cameras, or other devices that process data using processing circuitry (e.g., application specific integrated circuits (ASICs), digital signal processors (DSP), graphics processing unit (GPU), or central processing units (CPU)).

In some aspects, a device may include a digital signal processor or a processor (e.g., an application processor) including specific functionality for data processing. Operations on different kinds of data may be performed by different processors, or various operations may be split between the various data processing circuitry (e.g., ASICs, DSP, GPU, CPU, NPU). In some embodiments, the methods and techniques disclosed herein may be adapted for use in a neural signal processor (NSP) in which one or more parameters of data processing are controlled based on output from a machine learning (ML) model executed by the NSP.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos (with associated or embedded sounds) in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of a system-on-chip (SoC) configured for performing signal processing according to one or more aspects of this disclosure.

FIG. 2 is a block diagram illustrating an example implementation of aspects of this disclosure in a processing system for a mobile device according to one or more aspects of the disclosure.

FIG. 3 is a block diagram illustrating an example processing pipeline for a central processing unit (CPU) according to one or more aspects of the disclosure.

FIG. 4 shows a flow chart of an example method for providing a scale instruction for data scaling according to one or more aspects of this disclosure.

Like reference numbers and designations in the various drawings indicate like elements.

### DETAILED DESCRIPTION

The present disclosure provides systems, apparatus, methods, and computer-readable media that support improved integrated circuit operation, including techniques for improved scaling of data inputs, including floating points values.

In many computational tasks involving floating-point arithmetic, intermediate calculations may suffer from overflow or underflow due to the finite range and precision of floating-point representations. For example, when computing the Euclidean distance using the formula \sqrt{a²+b²+c²}, squaring very large values of a, b, or c may result in an incorrect infinity (Inf) result, while squaring very small values may result in an incorrect zero result. Despite these intermediate issues, the final computed distance might still fall within a representable range if calculated accurately.

Existing techniques may attempt to mitigate these issues through software-based workarounds. One common method involves converting operands to a higher precision format before performing calculations. This approach may increase computational overhead, require additional instructions for data type conversions, and might not be feasible if higher precision formats are unsupported by a CPU. Another technique may manually scale input values to prevent intermediate overflow or underflow and then scale the result back. This method often involves extra arithmetic operations such as divisions and multiplications, introduces rounding errors at each step, and requires conditional checks to handle edge cases like zero or infinity. These software-based solutions may lead to poor performance due to the additional instructions and processing overhead. Furthermore, the cumulative rounding errors from multiple arithmetic operations may degrade the precision of the final result.

One solution to this problem is to implement a new hardware CPU instruction, a scale instruction, that efficiently scales multiple floating-point inputs and produces normalized outputs along with an optional scaling-related value. The scale instruction may be integrated into a CPU, such as in an ALU of a CPU. In certain implementations, the scale instruction may manipulate the exponent bits of the floating-point representations directly, avoiding traditional floating-point arithmetic operations. In certain implementations, the scale instruction may operate by extracting the exponent bits from the input values to determine an appropriate scaling factor, such as the nearest non-bigger power of two. The scale instruction may also adjust the exponent bits of the inputs to produce scaled outputs. This method may avoid actual division or multiplication in the data path, enhancing performance and conserving computational resources. The scale instruction may also be configurable to support various scaling strategies and handle a variable number of inputs, making it adaptable to a wide range of applications.

Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

Particular implementations of the subject matter described in this disclosure may be implemented to realize one or more of the following potential advantages or benefits. In some aspects, the present disclosure provides techniques for efficient hardware-based scaling of floating-point values that may be particularly beneficial in applications prone to numerical instability, such as graphics rendering and scientific computations. For example, by reducing the number of instructions and avoiding software-based scaling workarounds, these techniques may enhance performance by up to 10-15% in computation-intensive scenarios. Such performance improvements may also result in improved battery life, such as by reducing the total number of CPU instructions performed.

Additionally, by manipulating exponent bits directly and scaling by powers of two, the present techniques may minimize rounding errors and preserve the precision of the original inputs. This approach may improve the reliability of computations involving floating-point arithmetic, leading to more accurate results. Furthermore, the hardware-based solution may reduce the developer burden by simplifying code and eliminating the need for complex software scaling routines, allowing developers to focus on higher-level algorithmic concerns rather than low-level numerical issues.

The detailed description set forth below, in connection with the appended drawings to which the text references, is intended as a description of various embodiments and is not intended to limit the scope of the disclosure. Rather, the detailed description includes specific details for the purpose of providing a thorough understanding of the subject matter of this disclosure. It will be apparent to those skilled in the art that these specific details are not required in every case and that, in some instances, well-known structures and components are shown in block diagram form for clarity of presentation.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

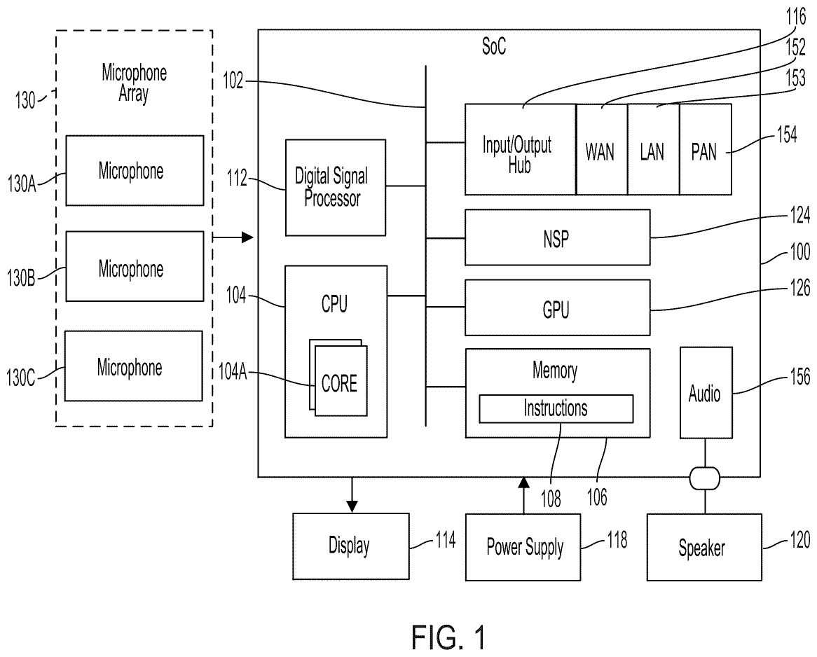

FIG. 1 shows a block diagram of a system-on-chip (SoC) configured for performing signal processing according to one or more aspects of this disclosure. The SoC 100 may include several components coupled together through a bus 102, which may be a network-on-a-chip (NoC) or a plurality of NOCs interconnecting various components. For example, although FIG. 1 illustrates several components coupled to the bus 102, the several components may be coupled to different busses with additional busses connecting the different busses to provide a path for communication between the components.

One example component in the SoC 100 is a DSP 112 for signal processing. The DSP 112 may process audio signals received from microphones 130A, 130B, and 130C of microphone array 130. The DSP 112 may include hardware customized for performing a limited set of operations on specific kinds of data. For example, a DSP may include transistors coupled together to perform operations on streaming data and use memory architectures and/or access techniques to fetch multiple data or instructions concurrently. Such configurations may allow the DSP 112 to operate on real-time data, such as video data, audio data, or modem data, in a power-efficient manner.

The SoC 100 also includes a CPU 104 and a memory 106 storing instructions 108 (e.g., a memory storing processor-readable code or a non-transitory computer-readable medium storing instructions) that may be executed by a processor of the SoC 100. The CPU 104 may be a single central processing unit (CPU) or a CPU cluster comprising two or more cores such as core 104A. The CPU 104 may include hardware capable of performing generic operations on many kinds of data, such as hardware capable of executing instructions from the Advanced RISC Machines (ARM®) instruction set, such as ARMv8 and ARMv9. For example, a CPU 104 may include transistors coupled together to perform operations for supporting executing an operating system and user applications (e.g., a camera application, a multimedia application, a gaming application, a productivity application, a messaging application, a videocall application, an audio recording application, a video recording application). The CPU 104 may execute instructions 108 retrieved from the memory 106. In some embodiments, the CPU 104 executing an operating system may coordinate execution of instructions by various components within the SoC 100. For example, the CPU 104 may retrieve instructions 108 from memory 106 and execute the instructions on the DSP 112.

The SoC 100 may further include a NSP 124 for executing machine learning (ML) models relating to multimedia applications. The NSP 124 may include hardware configured to perform and accelerate convolution operations involved in executing machine learning algorithms. For example, the NSP 124 may improve performance when executing predictive models such as artificial neural networks (ANNs) (including multilayer feedforward neural networks (MLFFNN), the recurrent neural networks (RNN), and/or the radial basis functions (RBF)). The ANN executed by the NSP 124 may access predefined training weights stored in the memory 106 for performing operations on user data.

The SoC 100 may be coupled to a display 114 for interacting with a user. The SoC 100 may also include a GPU 126 for rendering images on the display 114. In some embodiments, the CPU 104 may perform rendering to the display 114 without a GPU 126. In some embodiments, the GPU 126 may be configured to execute instructions for performing operations unrelated to rendering images, such as for processing large volumes of datasets in parallel.

The SoC 100 may include an integrated circuit, such as included in one of the DSP 112, CPU 104, NSP 124, GPU 126, to implement a scale instruction, as discussed herein. Specifically, the scale instruction may be implemented in the arithmetic logic unit (ALU) of the CPU 104, enabling efficient scaling of multiple floating-point inputs directly at the hardware level. This integration may allow the CPU 104 to manipulate exponent bits of floating-point representations without traditional arithmetic operations, enhancing performance and conserving computational resources.

Processing algorithms, techniques, and methods may be executed by at least one processor of the SoC 100, which may include execution by all steps on one of the processors (e.g., DSP 112, CPU 104, NSP 124, GPU 126) or may include execution of steps across a combination of one or more of the processors (e.g., DSP 112, CPU 104, NSP 124, GPU 126). In some embodiments, at least one of the CPU 104 or the DSP 112 executes instructions to perform various operations described herein, including the hardware-based scaling of data values using a scale instruction. For example, when performing computational tasks involving floating-point arithmetic. Data processing to determine “output” or “scaled” values, such as according to techniques described herein, may be applied to one or more data values in a sequence of data values.

Input/output components may be coupled to the SoC 100 through a hub 116 for input/output (I/O) devices. An example of a hub 116 is an interconnect to a peripheral component interconnect express (PCIe) bus. Example components coupled to hub 116 may be components used for interacting with a user, such as a touch screen interface and/or physical buttons. Some components coupled to hub 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna that may be shared by each of the WAN adaptor 152, LAN adaptor 153, and PAN adaptor 154, or coupled to multiple antennas configured for primary and diversity reception and/or configured for receiving specific frequency bands. In some embodiments, the WAN adaptor 152, LAN adaptor 153, and/or PAN adaptor 154 may share circuitry, such as portions of a radio frequency front end (RFFE).

Audio circuitry 156 may be integrated in SoC 100 as dedicated circuitry for coupling the SoC 100 to a speaker 120 external to the SoC 100, which may be a transducer such as a speaker (either internal to or external to a device incorporating the SoC 100) or headphones. The audio circuitry 156 may include coder/decoder (CODEC) functionality for processing digital audio signals. The audio circuitry 156 may further include one or more amplifiers (e.g., a class-D amplifier) for driving a transducer coupled to the SoC 100 for outputting sounds generated during execution of applications by the SoC 100. Functionality related to audio signals described herein may be performed by a combination of the audio circuitry 156 and/or other processors of the SoC (e.g., CPU 104, DSP 112, GPU 126, NSP 124).

The SoC 100 may couple to external devices outside the package of the SoC 100. For example, the SoC 100 may be coupled to a power supply 118, such as a battery or an adaptor to couple the SoC 100 to an energy source. The signal processing described herein may be adapted to and achieve power efficiency to support operation of the SoC 100 from a power supply 118 with limited capacity such as a battery. For example, operations may be performed on a portion of the SoC 100 configured for performing the operation at a lowest power consumption. As another example, operations themselves are performed in a manner that reduces an amount of computations to perform the operation, such that the algorithm is optimized for extending the operational time of a device while powered by a battery. In some embodiments, the operations described herein may be configured based on a type of power supply 118 providing energy to the SoC 100. For example, a first set of operations may be executed to perform a function when the power supply 118 is a wall adaptor. As another example, a second set of operations may be executed to perform a function when the power supply 118 is a battery.

The SoC 100 may also include or be coupled to additional features or components that are not shown in FIG. 1. Although components are shown integrated as a SoC 100, which may include all components built on a single semiconductor die with a common semiconductor substrate, other arrangements of the illustrated blocks different number of dies, substrates, and/or packages may be arranged to accomplish the same functionality described in this disclosure.

The memory 106 may include a non-transient or non-transitory computer readable medium storing computer-executable instructions as instructions 108 to perform all or a portion of one or more operations described in this disclosure. The instructions 108 may include a multimedia application (or other suitable application such as a messaging application) to be executed by the SoC 100 that records, processes, or outputs audio signals. The instructions 108 may also include other applications or programs executed by the SoC 100, such as an operating system and applications other than for multimedia processing.

In addition to instructions 108, the memory 106 may also store audio data. The SoC 100 may be coupled to an external memory and configured to access the memory for writing output audio files for later playback or long-term storage. For example, the SoC 100 may be coupled to a flash storage device comprising NAND memory for storing video files (e.g., MP4-container formatted files) including audio tracks and/or storing audio recordings (e.g., MPEG-1 Layer Three files, also referred to as MP3 files). Portions of the video or audio files may be transferred to memory 106 for processing by the SoC 100, with the resulting signals after processing encoded as video or audio files in the memory 106 for transfer to the long-term storage.

While the SoC 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. For example, a mobile gaming device may include the SoC 100 with a display and multiple user controls integrated in a single unit. As another example, a mobile phone may include the SoC 100 with a display and modem for communicating on one or more wireless networks through one or more antennas. As such, the present disclosure is not limited to a specific device or configuration of components.

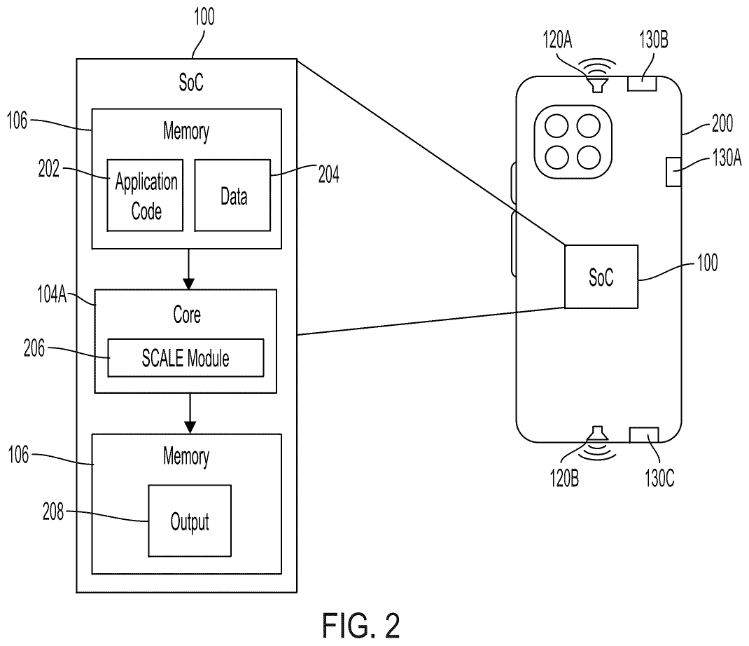

The SoC of FIG. 1 may be operated to obtain improved computational performance and precision in data operations, thereby enhancing user experience by providing faster processing times and more reliable results in applications requiring calculations. One example integration of aspects of this disclosure into a mobile device are shown in FIG. 2 and described below.

FIG. 2 is a block diagram illustrating an example implementation of aspects of this disclosure in a processing system for a mobile device according to one or more aspects of the disclosure. SoC 100 may include 104A and memory 106, similar to that shown in FIG. 1. The memory 106 may store the application code 202 and data 204. The application code may include instructions that, when executed by core 104A or other processing circuitry (such as NSP 124, GPU 126, and/or DSP 112), causes the SoC, and thus the mobile device 200 to perform operations described by the instructions (examples of which are described herein). The core 104A may retrieve instructions, such as application code 202, from memory 106 and execute those instructions to operate on data 204. Execution of instructions by the core 104A may include execution of logic in scale module 206. Scale module 206 may implement a hardware-based scale instruction, enabling efficient scaling of multiple floating-point inputs by directly manipulating their exponent bits. After executing instructions, some of which may operate on data 204, the core 104A may generate output 208, which may be stored in memory 106.

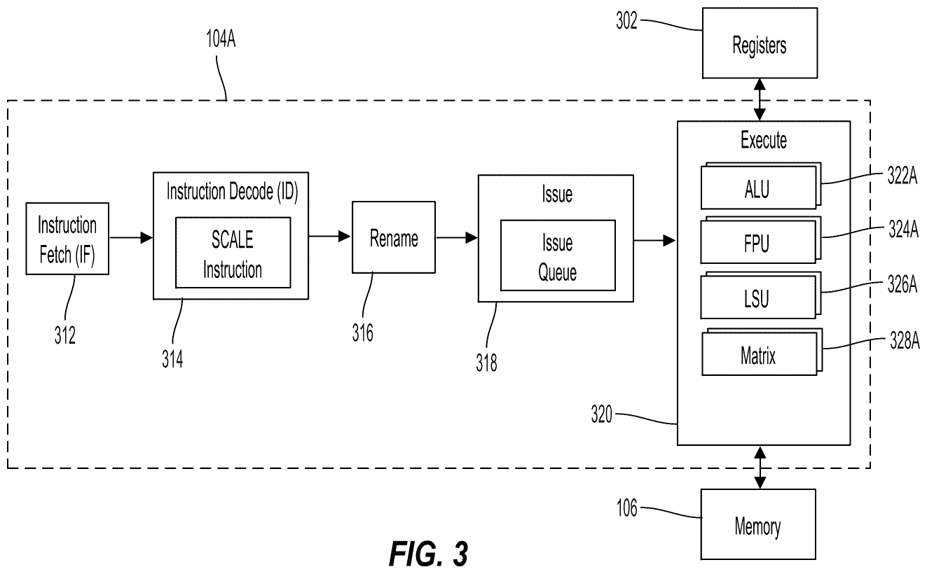

The core 104A or other processing circuitry may execute the instructions, such as application code 202, using one or more processing pipelines. FIG. 3 is a block diagram illustrating an example processing pipeline for a central processing unit (CPU) according to one or more aspects of the disclosure. Although executing of application code and instructions by a CPU are described with reference to FIG. 3 and other aspects of this disclosure, the techniques and operations described herein with reference to FIG. 3 and elsewhere may be similarly applied to the operation of other processing circuitry such as NSP 124, GPU 126, and/or DSP 112.

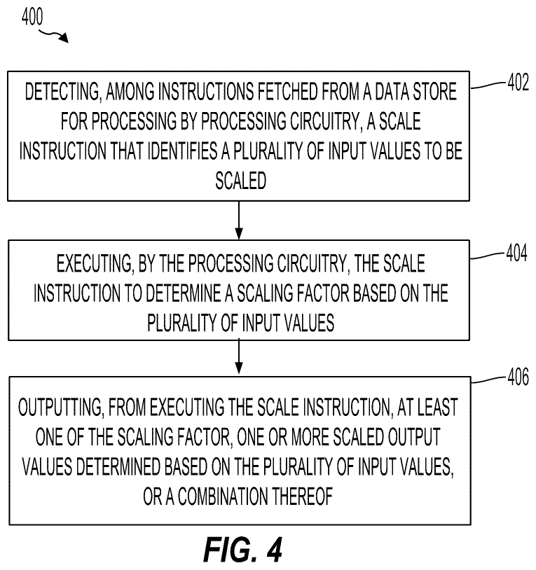

The core 104A is shown with one processing pipeline including a number of pipeline stages, although processing circuitry may include two or more pipeline states and/or different numbers of stages. The pipeline begins with a first stage of an instruction fetch (IF) stage 312 instructions from a data store (e.g. an instruction cache or memory 106). The IF stage 312 is followed by an instruction decode (ID) stage 314 for decoding the fetched instructions. The ID stage 314 may decode a scale instruction which causes the core 104A to perform operations described in relation to FIG. 4. A third stage is a rename stage 316 for performing register renaming, and a fourth stage is an issue stage 318 for issuing instructions for execution. The issue stage 318 may temporarily store instructions in an issue queue while waiting for appropriate execution resources to be available. After the issue stage 318 is execution stage 320 for executing the issued instructions. The execution stage 320 includes a number of execution units for executing different kinds of instructions, such as an arithmetic logic unit (ALU) 322A for executing scalar and/or vector data processing instructions, a floating point unit (FPU) 324A for executing floating point instructions, and a load/store unit (LSU) 326A for executing load/store instructions for transferring data between registers 302 and a data store such as a data cache or memory 106. A translation look aside buffer (TLB) may be used by the LSU 326A for caching address translation data for translating virtual addresses to physical addresses. The registers 302 may include scalar registers for storing scalar operands, vector registers 36 for storing vector operands, and/or predicate registers 38 for storing predicate values.

A pipeline may be configured as an out-of-order pipeline, which supports execution of instructions in a different order that the program order by reordering instructions after being fetched by the IF stage 312. The pipeline may be configured for out-of-order instruction by the issue stage 318 being configured to, when an instruction's operands become available then the instruction may be issued for execution by the execution stage 320 even if an earlier instruction in the program order is still waiting for its operands. To increase the extent to which reordering of instructions is possible, the rename stage 316 may be configured to map architectural register specifiers specified by the fetched instructions to physical register specifiers identifying physical registers provided in hardware. The pipeline may alternatively be configured as an in-order pipeline, in which program instructions are executed in their original program order as contained in application code 202.

Other examples of a pipeline architectures from FIG. 3 that may be usable with aspects of the scale instruction or operations described herein may have different stages or different combinations of execution units in the execution stage 320. For example, some pipelines may have an additional dispatch stage between the ID stage 314 and the issue stage 318.

The device of FIG. 1, FIG. 2, or FIG. 3 may be configured to perform operations described with reference to FIG. 4 to efficiently scale data values using a hardware scale instruction. FIG. 4 shows a flow chart of an example method for scaling data values with a scale instruction according to one or more aspects of this disclosure. The operations of FIG. 4 may result in enhanced computational efficiency, reduced processing overhead, minimized rounding errors, and improved precision in floating-point computations, which results in an improved user experience.

Each of the operations described with reference to FIG. 4 may be performed by one or a combination of the processors of the SoC 100.

The operations described with reference to blocks of FIG. 4 may be performed on a CPU 104 of the SoC 100 illustrated in FIG. 1. However, the operations may alternatively be performed by other processing circuitry of FIG. 1, including one or more of the CPU 104, the DSP 112, the GPU 126, or the NSP 124. In some embodiments, operations may be executed using a combination of processing circuitry from across the CPU 104, the DSP 112, the GPU 126, or the NSP 124. For example, in an example multimedia application, the CPU 104 may record audio signals from the microphone array 130 to memory 106 as part of the operations. The DSP 112 may then perform the operations of blocks 304 and 306 on the audio signals stored in memory 106, after which output signals determined by the DSP 112 may be stored in memory 106, output to audio circuitry 156 for reproduction, and/or transmitted to another device through one or more of the WAN adaptor 152, LAN adaptor 153, and/or PAN adaptor 154. In another example, the processor performing the operations of blocks below may be dedicated logic circuitry for performing certain operations.

At block 402, the processing circuitry 104 may be configured to detect, among instructions fetched from the memory 106 for execution, a scale instruction that identifies a plurality of input values to be scaled. In certain implementations, the processing circuitry 104 retrieves instructions from the memory 106 through an instruction fetch unit as part of the instruction fetch (IF) stage 312 in the processing pipeline illustrated in FIG. 3. The instructions may include operational codes (opcodes) and operands necessary for execution. The scale instruction may be a specialized instruction within the instruction set architecture (ISA) that enables efficient scaling of floating-point input values directly at the hardware level.

The processing circuitry 104 may identify the plurality of input values within the instruction encoding or operands for the scale instruction. In certain implementations, the instruction encoding of the scale instruction includes specific fields or bits that specify the registers or memory locations containing the input values to be scaled. For instance, the scale instruction may have an opcode unique to scaling operations, followed by operand fields that reference the input registers. These operand fields may use register identifiers to indicate which floating-point registers hold the input values.

The processing circuitry 104 may fetch instructions from the memory 106 using the instruction fetch unit during the IF stage 312. After fetching, the processing circuitry 104 may proceed to the instruction decode (ID) stage 314, where an instruction decoder analyzes the opcode and operand fields to determine the instruction type and required execution resources. The instruction decoder may include hardware mechanisms to recognize the unique opcode of the scale instruction, differentiating it from standard instructions. The instruction decoder may employ pattern-matching circuits that compare the opcode bits of the fetched instruction with predefined patterns corresponding to known instructions, including the scale instruction.

In the instruction set architecture, the scale instruction may have a specific format that distinguishes it from other instructions. For example, the scale instruction may have a dedicated opcode not used by any other instruction type. The syntax of the scale instruction may be designed to include multiple operand fields to accommodate the plurality of input values. In certain implementations, the scale instruction format may be:
SCALE destination_registers, source_registers, scaling_options
   where:
destination_registers represent the registers where the scaled output values will be stored.
source_registers specify the registers containing the input values to be scaled.
scaling_options include bits or fields that configure the scaling strategy or output preferences.
   For instance, a scale instruction for 3D vector normalization may be identified as:
SCALE r1, r2, r3, r4, r5, r6, options
   where ‘r1’, ‘r2’, ‘r3’ are destination registers for the scaled outputs, ‘r4’, ‘r5’, ‘r6’ are source registers containing the input values, and ‘options’ specify scaling configurations.

The processing circuitry 104 may be configured to utilize an instruction decoder in the ID stage 314 to interpret the opcode and operands of the fetched instructions. Upon detecting the scale instruction, the instruction decoder signals the subsequent pipeline stages to prepare for its execution. This preparation may involve allocating necessary resources, such as registers and execution units, and scheduling the scale instruction for execution in the execution stage 320.

The processing circuitry 104 may include an instruction cache to store recently fetched instructions, enhancing the efficiency of instruction retrieval. The coordination between the IF stage 312, ID stage 314, and the execution units ensures that the scale instruction is accurately detected and executed, leveraging the hardware capabilities for optimized performance.

At block 404, the processing circuitry 104 may be configured to execute the scale instruction to determine a scaling factor based on the plurality of input values. In certain implementations, upon detecting the scale instruction as described above, the processing circuitry 104 proceeds to execute the instruction based on the received input values. These input values may be floating-point numbers stored in registers or memory locations accessible to the processing circuitry 104. The execution may include determining a scaling factor that is used to scale the input values.

In certain implementations, executing the scale instruction includes adjusting exponent bits of the floating-point representations of the plurality of input values using integer logic operations to generate scaled output values, such as based on the determined scaling factor. Floating-point numbers may typically be represented using a sign bit, exponent bits, and fraction bits. By manipulating the exponent bits directly, the processing circuitry 104 can scale the input values efficiently without directly performing floating-point multiplication or division operations. For example, consider input values represented in a format where each floating-point number consists of a 1-bit sign, an 8-bit exponent, and a 23-bit fraction (mantissa). In this representation, adjusting the exponent bits effectively scales the number by powers of two, and the processing circuitry 104 can perform this adjustment using integer addition or subtraction operations on the exponent bits. In particular implementations, after determining the scaling factor, the processing circuitry 104 may adjust the exponent bits of each input value by subtracting the scaling factor's exponent, effectively scaling the inputs.

In certain implementations, the processing circuitry 104 includes an arithmetic logic unit (ALU) 322A configured to perform the exponent bit adjustments and execute the scale instruction in hardware. The ALU 322A is responsible for executing arithmetic and logical operations within the execution stage 320 of the processing pipeline depicted in FIG. 3. The ALU 322A performs exponent bit adjustments by utilizing integer logic circuits designed to manipulate the bit patterns of the floating-point numbers.

In additional or alternative implementations, executing the scale instruction may include performing floating-point division operations to scale the plurality of input values by the scaling factor. For example, the processing circuitry 104 may utilize a floating-point unit configured to perform the division operations as part of executing the scale instruction in hardware.

In certain implementations, the scaling factor may be determined by determining a first value based on the plurality of input values according to one or more scaling strategies. In various implementations, the first value may be a maximum absolute value among the plurality of input values, a minimum absolute value among the plurality of input values, an input scaling factor identified by the scale instruction, or a combination thereof.

In implementations where the first value is a maximum absolute value among the plurality of input values, the ALU 322A may compute the absolute value of each input by setting the sign bit to zero and then compare the exponents to identify the maximum value. In implementations where the first value is a minimum absolute value among the plurality of input values, the ALU 322A may compute the absolute value of each input by setting the sign bit to zero and then compare the exponents to identify the minimum value.

In additional or alternative implementations, determining the scaling factor may include adjusting the first value to a largest power of two that is less than or equal to the maximum absolute value. This adjustment may be achieved by modifying the floating-point representation of the first value by setting the fraction bits to zero, thereby retaining only the exponent and sign bits, and taking the largest exponent value of the first value as the scaling factor. For example, if the first value is 14.75, its floating-point representation can be modified by setting the fraction bits to zero, resulting in the value 8.0. This adjusted value, 8.0, is the largest power of two less than or equal to 14.75, and may be used as or may be used to determine the scaling factor.

As one example, consider an input value with the following representation:
A sign bit S=0 (positive number),
Exponent bits E=130, and
Fraction bits representing F=0.75.
   The input value may be computed as:

$${N}_{o r i g inal} = {( - 1 )}^{0} \times ( 1 + 0.75 ) \times {2}^{( 130 - 127 )} = 1.75 \times {2}^{3} = 14$$

Adjusting the fraction bits to zero:

$${N}_{adjusted} = 1.0 \times {2}^{( 130 - 127 )} = 1.0 \times {2}^{3} = 8$$

Thus, N_{adjusted}=8 is the largest power of two less than or equal to N_{original}=14.

In certain implementations, the processing circuitry may utilize this adjusted value as the scaling factor. In such instances, to generate the scaled output values, the processing circuitry may adjust the exponent bits of the input values by subtracting the exponent value (E_{scale}) for N_{adjusted} from each input's exponent value (Eᵢₙₚᵤₜ):

$${E}_{scaled} = {E}_{input} - {E}_{scale} .$$

In certain implementations, the scaling factor may be determined as the reciprocal of the first value. In such instances, the reciprocal scaling factor may be determined by adjusting the exponent bits of the maximum absolute value.

At block 406, the processing circuitry 104 may be configured to output, from executing the scale instruction, at least one of the scaling factor, one or more scaled output values determined based on the plurality of input values, or a combination thereof. In certain implementations, the instruction encoding of the scale instruction specifies whether to output the scaling factor, the scaled output values, or both. Such configurations may allow the processing circuitry 104 to tailor the outputs based on the requirements of subsequent computations.

For example, the instruction encoding may include specific bits that indicate the desired output option. An ‘Output Control’ field within the instruction encoding can be used to select between different output scenarios. If the Output Control field is set to a value corresponding to outputting only the scaling factor, the processing circuitry 104 provides the scaling factor as the sole output. This scenario is useful in applications where the scaling factor is needed for further calculations, but the scaled input values are not required immediately. As another example, when the Output Control field is set to indicate that only the scaled output values are to be provided, the processing circuitry 104 outputs the scaled values without the scaling factor. In situations where both the scaling factor and the scaled output values are needed, the Output Control field can be set accordingly to instruct the processing circuitry 104 to output both.

The methods by which the processing circuitry 104 outputs the scaling factor and scaled output values involve writing these values into designated registers or memory locations accessible for subsequent computations. In certain implementations, the scaled output values may be stored in the same registers that initially held the input values, especially when overwriting is employed. Alternatively, if specified by the instruction encoding, the scaled values can be stored in different registers. The scaling factor may typically be output to a register as well, which may be specified by the instruction, or may be a preconfigured or default register.

In certain implementations, the scale instruction may utilize instruction encoding that allows for configuring of options for determining the scaling factor. The instruction encoding may comprise one or more bits specifying the scaling strategy. For example, a scaling instruction configured to receive three data input values may be encoded in a format that includes an 8-bit opcode field, three 5-bit source register fields, three 5-bit destination register fields, and a 2-bit scaling option field. In such implementations, a scaling option value of ‘00’ may indicate selecting the first value as scaling factor, a scaling option value of ‘01’ may indicate selecting the scaling factor by adjusting the first value to the largest power of two less than or equal to maximum absolute value, and a scaling option value of ‘10’ may indicate selecting the scaling factor by calculating the reciprocal of the adjusted first value. In further implementations, the scale instruction may utilize an instruction encoding that allows for configuring of options to output the scaling factor. Continuing the previous example, the instruction encoding may include a 1-bit output options field, where a value of ‘0’ indicates that the scaling factor should be output and a value of ‘1’ indicates that the scaling factor should not be output. As another example, the output options may further indicate whether scaled values should be output. Continuing the previous example, the instruction encoding may include a 2-bit output options field, where a value of ‘00’ indicates to output only the scaling factor, a value of ‘01’ indicates to output only the scaled output values, and a value of ‘10’ indicates to output both the scaling factor and the scaled output values.

The scaled output values may typically maintain the sign of the original input values during exponent bit adjustments performed by the processing circuitry 104. For example, in floating-point representations, the sign bit indicates the positivity or negativity of the number. Since scaling by adjusting exponent bits involves modifying only the exponent portion of the floating-point number, the sign bit remains unchanged. As explained above, the processing circuitry 104 may be configured to manipulate the exponent bits to scale the magnitude of the input values while preserving the sign bit.

The processing circuitry 104 may further be configured to use the scaled output values and the scaling factor in subsequent computations to prevent overflow or underflow in floating-point operations. In certain implementations, the processing circuitry 104 utilizes these scaled values to perform mathematical calculations that would otherwise risk numerical instability due to extreme input magnitudes. For example, when calculating the Euclidean distance in three-dimensional space, the processing circuitry 104 computes the distance D as:

$$D = \sqrt{{a}^{2} + {b}^{2} + {c}^{2}}$$

where a, b, and c are the components of a vector. If a, b, or c have very large or very small magnitudes, squaring these values may cause overflow or underflow. By applying the scale instruction, the processing circuitry 104 obtains scaled output values a′, b′, and c′, and a scaling factor S. The distance calculation becomes:

$$D = S \times \sqrt{{a}^{′2} + {b}^{′2} + {c}^{′2}}$$

Since a′, b′, and c′ are adjusted to a normalized range, squaring them does not result in overflow or underflow, and the scaling factor S rescales the result to the correct magnitude.

As another example, for vector normalization, the processing circuitry 104 calculates a unit vector \vec{u} from a given vector \vec{v} with components a, b, and c. The normalization may be determined as:

$$\vec{u} = \frac{\vec{v}}{\vert \vec{v} \vert} = \frac{1}{\sqrt{{a}^{2} + {b}^{2} + {c}^{2}}} \times ( a , b , c )$$

By using the scaled values and scaling factor, the processing circuitry 104 computes:

$$\vec{u} = \frac{1}{S \times \sqrt{{a}^{′2} + {b}^{′2} + {c}^{′2}}} \times S \times ( {a}^{′} , {b}^{′} , {c}^{′} ) = \frac{( {a}^{′} , {b}^{′} , {c}^{′} )}{\sqrt{{a}^{′2} + {b}^{′2} + {c}^{′2}}}$$

This approach avoids overflow or underflow during both the magnitude calculation and the division, as the scaled values are within the supported range.

Thus, using the scaled output values prevents numerical errors in these computations by maintaining the operands within a representable range for floating-point numbers. The scaling factor adjusts the final result to the correct magnitude without introducing additional floating-point operations that might increase rounding errors.

In certain implementations, the scaling instruction may specify an input scaling factor, which may be used to more efficiently process vectors with a high dimension. In particular, the scaling instruction may be called multiple times consecutively to successively scale high-dimension vectors. In such instances, the detected scale instruction may identify an input scaling factor, and executing the scaling instruction may include comparing a first scaling factor determined based on the plurality of input values to the input scaling factor and determining an output scaling factor based on the comparison. In certain instances, the first scaling factor may be determined based on the first value, discussed above. In certain implementations, if the first scaling factor is greater than the input scaling factor, the output scaling factor may be determined as the first scaling factor and, if the first scaling factor is not greater than the input scaling factor, the output scaling factor may be determined as the second scaling factor. Additionally, if the first scaling factor is greater than the input scaling factor, executing the scale instruction may include determining scaled output values based on a difference between the input scaling factor and the output scaling factor.

For example, consider a scenario involving the computation of the length of a high-dimensional vector, where hardware constraints require processing the vector components in subsets. The processing circuitry 104 may utilize the scale instruction iteratively to handle different groups of components, while maintaining consistent scaling across iterations. In the first iteration, the processing circuitry 104 processes input values a, b, c and determines a first scaling factor S₀ based on these inputs. The scale instruction identifies an input scaling factor Sᵢₙₚᵤₜ, which may be an initial default value or derived from prior computations. The processing circuitry 104 may then compare S₀ with Sᵢₙₚᵤₜ. If S₀>Sᵢₙₚᵤₜ t, the output scaling factor Sₒᵤₜₚᵤₜ may be set to S₀, and the input values may be scaled accordingly. If S₀≤Sᵢₙₚᵤₜ, the output scaling factor Sₒᵤₜₚᵤₜ is set to Sᵢₙₚᵤₜ, and the input values may not be scaled. In subsequent iterations, the processing circuitry 104 processes additional input values d, e, f, g, . . . using the output scaling factor from the previous iteration as the new input scaling factor.

As another example, the scaling instruction may be called successively as:

// First SCALE instruction:
SCALE scaling_factor0, scaled_number_a, scaled_number_b, scaled_number_c, a, b, c
// Compute intermediate value based on scaled numbers:
value_x = compute_value(scaled_number_a, scaled_number_b, scaled_number_c)
// Second SCALE instruction:
SCALE scaling_factor1, scaled_number_x, scaled_number_d, scaled_number_e,
scaling_factor0, value_x, d, e
// Compute next intermediate value based on new scaled numbers:
value_x2 = compute_value(scaled_number_x, scaled_number_d, scaled_number_e)
// Third SCALE instruction:
SCALE scaling_factor2, scaled_number_x2, scaled_number_f, scaled_number_g,
scaling_factor1, value_x2, f, g
// Continued as needed
. . .

In certain implementations, executing the scale instruction enhances computational efficiency by reducing the number of instructions executed compared to performing equivalent scaling operations in software. Traditional software-based methods involve multiple instructions, including comparisons, divisions, multiplications, and conditionals. The scale instruction consolidates these operations into a single instruction executed by the processing circuitry 104.

These improvements are realized through the hardware optimization inherent in the scale instruction. By performing exponent adjustments at the hardware level, the processing circuitry 104 eliminates the overhead of multiple software instructions and reduces execution time. This optimization frees up processing resources and allows for faster computation, which is particularly beneficial in performance-critical applications.

Executing the scale instruction also reduces rounding errors by minimizing the number of arithmetic operations performed. Each floating-point arithmetic operation introduces potential rounding errors due to the finite precision of the representation. By adjusting exponent bits directly, the processing circuitry 104 performs scaling operations without actual arithmetic multiplication or division, thereby preserving the significant digits of the input values.

The processing circuitry 104 may be configured to ensure compliance with floating-point standards, such as IEEE 754, including handling of special values like zero, infinity (Inf), and Not a Number (NaN). In certain implementations, when the scaling factor is a special number such as Inf or zero, the processing circuitry 104 utilizes special integer logic within the scale instruction to appropriately scale the data as specified by the scale instruction. For example, if the scaling factor is infinity, scaling finite input values by dividing or multiplying may result in undefined or invalid operations. The processing circuitry 104 may accordingly be configured to determine when the scaling factor indicates an Inf value and to adjust the scaled output values accordingly (such as setting the scaled output values to zero) As another example, if the scaling factor is zero, scaling input values by zero may lead to infinite or undefined results. The processing circuitry 104 may accordingly be configured to determine when the scaling factor indicates a value of zero and to adjust the scaled output values accordingly (such as setting the scaled output values to Inf). As a further example, when the scaling factor or any of the input values indicates a value of NaN, the processing circuitry 104 may be configured to set the scaled output values are set to NaN.

The examples discussed above primarily focus on floating-point representations with a radix of two. It should be understood that similar techniques may be used with floating-point representations with a radix other than two, such as radix ten. For example, the processing circuitry 104 may be configured to execute the scale instruction on floating-point numbers that follow the IEEE 754 standard for both binary (radix 2) and decimal (radix 10) arithmetic. When operating with different radix bases, the processing circuitry 104 may be configured to adjust the scaling techniques and/or hardware implementations to accommodate the specified radix. For example, for floating-point numbers with radix ten, each number may be represented using a sign bit, exponent digits, and significand digits. In such instances, the processing circuitry 104 may be configured to adjust the exponent digits when performing scaling operations by modifying the decimal exponent to scale the input values. In particular, the processing circuitry 104 may be configured determine the scaling factor based on the plurality of input values represented in radix ten. The scaling factor may be selected as a power of ten that normalizes the input values for subsequent computations. The processing circuitry 104 may adjust the exponent digits of the input values by subtracting the scaling factor's exponent, effectively scaling the inputs without performing direct decimal multiplication or division operations.

In certain implementations, the instruction encoding of the scale instruction may include specific bits that specify the radix of the floating-point representations used in the scaling operations. This configuration allows the processing circuitry 104 to interpret and process the input values correctly based on the specified radix. A ‘Radix Indicator’ field within the instruction encoding may be used to select between radix two and radix ten representations. A value of ‘0’ in the Radix Indicator field may indicate binary floating-point numbers, while a value of ‘1’ may indicate decimal floating-point numbers.

The processing circuitry 104 may further be configured to detect, by a compiler during code compilation, patterns corresponding to scaling operations and generate the scale instruction to replace the detected patterns for optimized execution. In certain implementations, the compiler analyzes the source code to identify sequences of instructions that perform manual scaling of input values to prevent overflow or underflow.

Identifying sequences involves searching for code patterns where maximum absolute values are calculated, inputs are divided by these values, and results are scaled back after computations. For example, the compiler may be configured to recognize code that matches patterns such as:

```
float compute_magnitude(float a, float b) {
  float max_val = fmaxf(fabsf(a), fabsf(b));
  if (max_val == 0.0f) return 0.0f;
  float a_scaled = a / max_val;
  float b_scaled = b / max_val;
  return max_val * sqrtf(a_scaled * a_scaled + b_scaled * b_scaled);
}
```

Upon detecting code matching the patterns, the compiler may be configured to replace these patterns with the scale instruction. For example, the code above may be compiled as:

```
float compute_magnitude(float a, float b) {
  float scaling_factor;
  SCALE(&a, &b, &scaling_factor, options);
  return scaling_factor * sqrtf(a * a + b * b);
}
```

In one or more aspects, techniques for improving device operation may include additional aspects, such as any single aspect or any combination of aspects described below or in connection with one or more other processes or devices described elsewhere herein. In a first aspect, an apparatus includes processing circuitry configured to perform data processing in response to instructions, where the processing circuitry is further configured to detect, among the instructions, a scale instruction that identifies a plurality of input values to be scaled; execute the scale instruction to determine a scaling factor based on the plurality of input values; and output at least one of the scaling factor, one or more scaled output values determined based on the plurality of input values, or a combination thereof. Additionally, the apparatus may perform or operate according to one or more aspects as described below. In some implementations, the apparatus includes a wireless device, such as a UE. In some implementations, the apparatus includes a remote server, such as a cloud-based computing solution, which receives image data for processing to determine output image frames. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect according to the first aspect, executing the scale instruction includes adjusting exponent bits of floating-point representations of the plurality of input values using integer logic operations to generate the one or more scaled output values.

In a third aspect according to the second aspect, the processing circuitry includes an arithmetic logic unit configured to perform the exponent bit adjustments and execute the scale instruction in hardware.

In a fourth aspect according to any one of the first through third aspects, determining the scaling factor includes determining a first value among the plurality of input values, where the first value comprises a minimum absolute value among the plurality of input values, a maximum absolute value among the plurality of input values, an input scaling factor identified by the scale instruction, or a combination thereof.

In a fifth aspect according to the fourth aspect, determining the scaling factor further includes determining an adjusted absolute value as a largest power of two that is less than or equal to the first value.

In a sixth aspect according to any one of the fourth and fifth aspects, the scaling factor is a reciprocal of the first value.

In a seventh aspect according to any one of the first through sixth aspects, the scale instruction comprises one or more bits specifying options for determining the scaling factor.

In an eighth aspect according to any one of the first through seventh aspects, the scale instruction comprises one or more bits specifying whether to output the scaling factor, the scaled output values, or a combination thereof.

In a ninth aspect according to any one of the first through eighth aspects, determining the scaling factor includes performing a floating-point division based on the plurality of input values and the scaling factor to determine the one or more scaled output values.

In a tenth aspect according to any one of the first through ninth aspects, the scale instruction identifies an input scaling factor, and executing the scale instruction includes comparing a first scaling factor determined based on the plurality of input values to the input scaling factor; and determining an output scaling factor based on the comparison.

In an eleventh aspect according to the tenth aspect, determining the output scaling factor based on the comparison includes determining, responsive to determining that the first scaling factor is greater than the input scaling factor, the output scaling factor as the first scaling factor; and determining, responsive to determining that the first scaling factor is not greater than the input scaling factor, the output scaling factor as the input scaling factor.

In a twelfth aspect according to the eleventh aspect, executing the scale instruction further includes determining, responsive to determining that the first scaling factor is greater than the input scaling factor, scaled output values based on a difference between the input scaling factor and the output scaling factor.

In a thirteenth aspect, a method includes detecting, among instructions fetched from a data store for execution by processing circuitry, a scale instruction that identifies a plurality of input values to be scaled; executing, by the processing circuitry, the scale instruction to determine a scaling factor based on the plurality of input values; and outputting, from executing the scale instruction, at least one of the scaling factor, one or more scaled output values determined based on the plurality of input values, or a combination thereof.

In a fourteenth aspect according to the thirteenth aspect, executing the scale instruction includes adjusting exponent bits of floating-point representations of the plurality of input values using integer logic operations to generate the one or more scaled output values.

In a fifteenth aspect according to the fourteenth aspect, the processing circuitry includes an arithmetic logic unit configured to perform the exponent bit adjustments and execute the scale instruction in hardware.

In a sixteenth aspect according to any one of the thirteenth through fifteenth aspects, determining the scaling factor includes selecting a maximum absolute value among the plurality of input values.

In a seventeenth aspect according to the sixteenth aspect, determining the scaling factor further includes determining an adjusted maximum absolute value as a largest power of two that is less than or equal to the maximum absolute value.

In an eighteenth aspect according to the seventeenth aspect, the scaling factor is the reciprocal of the maximum absolute value.

In a nineteenth aspect, a non-transitory computer-readable medium stores instructions which, when executed by a processor, cause the processor to perform operations including detecting, among instructions fetched from a data store for execution by processing circuitry, a scale instruction that identifies a plurality of input values to be scaled; executing, by the processing circuitry, the scale instruction to determine a scaling factor based on the plurality of input values; and outputting, from executing the scale instruction, at least one of the scaling factor, one or more scaled output values determined based on the plurality of input values, or a combination thereof.

In a twentieth aspect according to the nineteenth aspect, executing the scale instruction includes adjusting exponent bits of floating-point representations of the plurality of input values using integer logic operations to generate scaled output values.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIG. 3 may be combined with one or more blocks (or operations) described with reference to another of the figures. For example, one or more blocks (or operations) of FIG. 3 may be combined with one or more blocks (or operations) of FIG. 1 or FIG. 2. As another example, one or more blocks associated with FIG. 4 may be combined with one or more blocks (or operations) associated with FIGS. 1-3.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

In one or more aspects, the operations described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

The operations of a method or algorithm disclosed herein may be implemented in a processor-executable software module which may reside on a computer-readable medium and commercially made available as a computer program product as software. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc wherein disks usually reproduce data magnetically and discs reproduce data optically with lasers. Combinations of the above should also be included within the scope of computer-readable media.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward,” or “left” and “right” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus comprising:
processing circuitry to perform data processing in response to instructions, the processing circuitry configured to:
detect, among the instructions, a scale instruction that identifies a plurality of input values to be scaled;
execute the scale instruction to determine a scaling factor based on the plurality of input values; and
output at least one of the scaling factor, one or more scaled output values determined based on the plurality of input values, or a combination thereof.

2. The apparatus of claim 1, wherein executing the scale instruction comprises:
adjusting exponent bits of floating-point representations of the plurality of input values using integer logic operations to generate the one or more scaled output values.

3. The apparatus of claim 2, wherein the processing circuitry includes an arithmetic logic unit configured to perform the exponent bit adjustments and execute the scale instruction in hardware.

4. The apparatus of claim 1, wherein determining the scaling factor comprises:
determining a first value among the plurality of input values, wherein the first value comprises a minimum absolute value among the plurality of input values, a maximum absolute value among the plurality of input values, an input scaling factor identified by the scale instruction, or a combination thereof.

5. The apparatus of claim 4, wherein determining the scaling factor further comprises:
determining an adjusted absolute value as a largest power of two that is less than or equal to the first value.

6. The apparatus of claim 4, wherein the scaling factor is a reciprocal of the first value.

7. The apparatus of claim 1, wherein the scale instruction comprises one or more bits specifying options for determining the scaling factor.

8. The apparatus of claim 1, wherein the scale instruction comprises one or more bits specifying whether to output the scaling factor, the scaled output values, or a combination thereof.

9. The apparatus of claim 1, wherein determining the scaling factor comprises:
performing a floating point division based on the plurality of input values and the scaling factor to determine the one or more scaled output values.

10. The apparatus of claim 1, wherein the scale instruction identifies an input scaling factor, and wherein executing the scale instruction comprises:
comparing a first scaling factor determined based on the plurality of input values to the input scaling factor; and
determining an output scaling factor based on the comparison.

11. The apparatus of claim 10, wherein determining the output scaling factor based on the comparison comprises:
determining, responsive to determining that the first scaling factor is greater than the input scaling factor, the output scaling factor as the first scaling factor; and
determining, responsive to determining that the first scaling factor is not greater than the input scaling factor, the output scaling factor as the second scaling factor.

12. The apparatus of claim 11, wherein executing the scale instruction further comprises:
determining, responsive to determining that the first scaling factor is greater than the input scaling factor, scaled output values based on a difference between the input scaling factor and the output scaling factor

13. A method comprising:
detecting, among instructions fetched from a data store for execution by processing circuitry, a scale instruction that identifies a plurality of input values to be scaled;
executing, by the processing circuitry, the scale instruction to determine a scaling factor based on the plurality of input values; and
outputting, from executing the scale instruction, at least one of the scaling factor, one or more scaled output values determined based on the plurality of input values, or a combination thereof.

14. The method of claim 13, wherein executing the scale instruction comprises:
adjusting exponent bits of floating-point representations of the plurality of input values using integer logic operations to generate the one or more scaled output values.

15. The method of claim 14, wherein the processing circuitry includes an arithmetic logic unit configured to perform the exponent bit adjustments and execute the scale instruction in hardware.

16. The method of claim 13, wherein determining the scaling factor comprises:
selecting a maximum absolute value among the plurality of input values.

17. The method of claim 16, wherein determining the scaling factor further comprises:
determining an adjusted maximum absolute value as a largest power of two that is less than or equal to the maximum absolute value.

18. The method of claim 17, wherein the scaling factor is the reciprocal of the maximum absolute value.

19. A non-transitory, computer-readable medium storing instructions which, when executed by a processor, cause the processor to perform operations, comprising:
detecting, among instructions fetched from a data store for execution by processing circuitry, a scale instruction that identifies a plurality of input values to be scaled;
executing, by the processing circuitry, the scale instruction to determine a scaling factor based on the plurality of input values; and
outputting, from executing the scale instruction, at least one of the scaling factor, one or more scaled output values determined based on the plurality of input values, or a combination thereof.

20. The non-transitory, computer-readable medium of claim 18, wherein executing the scale instruction comprises:
adjusting exponent bits of floating-point representations of the plurality of input values using integer logic operations to generate scaled output values.
